(19) United States
(12) Patent Application Publication
(10) Pub. No.: US 2007/0146926 A1
(43) Pub. Date: Jun. 28, 2007

(54) Electronic device receiving apparatus and method of loading/unloading an electronic device at electronic device receiving apparatus

(75) Inventors: Hideyasu Hashiba, Kawasaki (JP); Yukio Ando, Kawasaki (JP); Keiichi Sasamura, Kawasaki (JP); Kenichi Yazaki, Kawasaki (JP); Yuuzou Hamanaka, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/361,059

(22) Filed: Feb. 24, 2006

(30) Foreign Application Priority Data
Dec. 27, 2005 (JP) 2005-375681

(51) Int. Cl. G11B 5/027

(52) U.S. Cl. 360/85

(57) ABSTRACT

An electronic device receiving apparatus having a sealed structure, includes a tape whereby an electronic device is received in the electronic device receiving apparatus. The tape elastically holds the electronic device and runs inside of the electronic device receiving apparatus. An opening part for loading/unloading and a tape extending mechanism are provided inside of the electronic device receiving apparatus. The opening part for loading/unloading is provided above the tape so that the electronic device is loaded onto and unloaded from the tape. The opening part for loading/unloading has an opening part configured to open the electronic device receiving apparatus. The tape extending part extends the tape in a direction substantially perpendicular to a running direction of the tape.

### BACKGROUND OF THE INVENTION

1. Field of the Invention

The present invention generally relates to electronic device receiving apparatuses and methods of loading/unloading electronic devices at the electronic device receiving apparatuses, and more specifically, to an electronic device receiving apparatus in which the electronic device is received by using a tape and a method of loading/unloading an electronic device at the electronic device receiving apparatus.

2. Description of the Related Art

A method for individually receiving plural electronic devices such as semiconductor devices in a carrier tape called an embossed tape so as to carry the electronic devices has been applied as a method for carrying the electronic devices without damaging the electronic device.

A structure of a semiconductor device receiving apparatus using a carrier tape is shown in FIG. 1. A cross-sectional view showing the carrier tape is shown in FIG. 2. A process for unloading a semiconductor device loaded in the carrier tape from the carrier tape is shown in FIG. 3.

Referring to FIG. 1, a semiconductor device receiving apparatus 1 includes a reel 2, a carrier tape 3 wound around the reel 2, and a cover tape 4. Plural concave parts 6 receiving semiconductor devices 5 are provided in the carrier tape 3 with designated gaps.

Referring to FIG. 2, where the semiconductor device 5 is received in the concave part 6 of the carrier tape 3, the cover tape 4 is adhered above the concave part 6 by contact bonding using a heated trowel, a contact bonding trowel, a thermal seal, or the like. Under this structure, it is possible to prevent the semiconductor device 5 from coming out from the concave part 6.

As shown in FIG. 3, in order to take out the semiconductor device 5 received in the concave part 6 from the carrier tape 3, the cover tape 4 is peeled off from the carrier tape 3. Then, the semiconductor device 5 is picked out from the concave part by using an adhesion jig 9.

However, under this structure, since a process for peeling off the cover tape 4 from the carrier tape 3 is necessary for taking out the semiconductor device 5 from the carrier tape 3, the number of operational processes and material cost and processing cost of the cover tape 4 are increased.

In addition, since sealing residue of the cover tape 4 remains at the carrier tape 3 after the carrier tape 3 is used, it is not possible to reuse the carrier tape 3.

Furthermore, since an unsealed semiconductor device or the like is extremely sensitive to dust or foreign particles, dust or foreign particles may affect connection quality at the time of forming a circuit. Accordingly, an operation for loading/unloading the semiconductor device 5 at the semiconductor device receiving apparatus 1 has to be done in a clean room or the like, and therefore the operation is complicated.

A semiconductor device receiving apparatus having a structure where a bottom wall on which a semiconductor devices is placed, side walls projecting from both side edges of the bottom wall, and a top wall with an opening are formed in an embossed tape, the semiconductor device being inserted through the opening of the top wall and held by the side walls in such a way as to be placed on the bottom wall, is suggested in Japanese Laid-Open Patent Application Publication No. 10-116842.

A method for tape-wrapping an electronic part by using a container having a shutter mechanism where the electronic part is received and an opening part for taking out the electronic part can be opened and closed, the container having a sealed structure where an arranging mechanism and peeling mechanism of an adhesive tape are provided at an inside thereof, is suggested in Japanese Laid-Open Patent Application Publication No. 9-226828.

However, in the semiconductor device receiving apparatus disclosed in Japanese Laid-Open Patent Application Publication No. 10-116842, although the above-mentioned problems in the case where the cover tape 4 shown in FIG. 1 through FIG. 3 is used can be solved because the cover tape 4 is not used, a problem of adhesion of the dust and foreign particles to the semiconductor device held by the embossed tape is not solved. Therefore, it is necessary to perform the operation for loading/unloading the semiconductor device at the embossed tape in a clean room, and this operation is complicated.

In addition, in method for tape-wrapping the electronic part in Japanese Laid-Open Patent Application Publication No. 9-226828, since the electronic part is fixed by using the adhesive tape, a structure of the container receiving the electronic part is complicated. Furthermore, the adhesive tape requires rewinding and therefore reusability of the adhesive tape is low.

### SUMMARY OF THE INVENTION

Accordingly, it is a general object of the present invention to provide a novel and useful electronic device receiving apparatus method of loading/unloading an electronic device at the electronic device receiving apparatus.

Another and more specific object of the present invention is to provide an electronic device receiving apparatus wherein a reusable carrier tape is used and whereby an electronic device can be protected against dust or foreign particles and a method of loading/unloading the electronic device at the electronic device receiving apparatus.

The above object of the present invention is achieved by an electronic device receiving apparatus having a sealed structure, including:

a tape whereby an electronic device is received in the electronic device receiving apparatus;

wherein the tape elastically holds the electronic device and runs inside of the electronic device receiving apparatus;

an opening part for loading/unloading and a tape extending mechanism are provided inside of the electronic device receiving apparatus;

the opening part for loading/unloading is provided above the tape so that the electronic device is loaded onto and unloaded from the tape;

the opening part for loading/unloading has an opening part configured to open the electronic device receiving apparatus; and

the tape extending part extends the tape in a direction substantially perpendicular to a running direction of the tape.

The above object of the present invention is also achieved by a method of loading/unloading an electronic device at an electronic device receiving apparatus, the electronic device receiving apparatus having a sealed structure in which the electronic device is received by using a tape, the tape being capable of elastically holding the electronic device and running inside of the electronic device receiving apparatus, the method including the steps of:

opening an opening part for loading/unloading of the electronic device receiving apparatus when a designated part of the tape is positioned below the opening part for loading/unloading; and

extending the tape inside of the electronic device receiving apparatus in a direction substantially perpendicular to a running direction of the tape, so that the electronic device is loaded to and unloaded from against the tape.

According to the present invention, it is possible to provide an electronic device receiving apparatus wherein a reusable carrier tape is used and so that an electronic device can be protected against dust or foreign particles and a method of loading/unloading the electronic device at the electronic device receiving apparatus.

Other objects, features, and advantages of the present invention will be come more apparent from the following detailed description when read in conjunction with the accompanying drawings.

### BRIEF DESCRIPTION OF THE DRAWINGS

FIG. 1 is a perspective view of a semiconductor device receiving apparatus using a carrier tape;

FIG. 2 is a cross-sectional view showing the carrier tape shown in FIG. 1;

FIG. 3 is a schematic view showing a process for unloading a semiconductor device loaded in the carrier tape from the carrier tape;

FIG. 4 is a perspective view of a semiconductor device receiving apparatus of an embodiment of the present invention and shows an internal structure of the semiconductor device receiving apparatus;

FIG. 5 is a cross-sectional view of the semiconductor device receiving apparatus shown in FIG. 4, seen in an arrow A direction;

FIG. 6 is a cross-sectional view of the semiconductor device receiving apparatus shown in FIG. 4, seen in an arrow B direction;

FIG. 7 is a perspective view of a carrier tape of the embodiment of the present invention;

FIG. 8 is a cross-sectional view of the carrier tape of the embodiment of the present invention;

FIG. 9 is a detailed perspective view showing a first example of a part shown by a dotted line F in FIG. 4;

FIG. 10 is a detailed perspective view showing a second example of the part shown by the dotted line F in FIG. 4;

FIG. 11 is a plan view (part 1) of a first aperture mechanism shown in FIG. 10 and shows a state where an opening part for loading/unloading is opened;

FIG. 12 is a plan view (part 2) of the first aperture mechanism shown in FIG. 10 and shows a state where the opening part for loading/unloading is closed;

FIG. 13 is a perspective view of the opening part for loading/unloading shown in FIG. 10, seen from an arrow K direction;

FIG. 14 is a schematic perspective view showing an internal structure of a semiconductor device receiving apparatus having an opening part for loading/unloading different from the opening part for loading/unloading of the semiconductor device receiving apparatus shown in FIG. 4;

FIG. 15 is a cross-sectional view of the semiconductor device receiving apparatus shown in FIG. 14, seen from an arrow A direction;

FIG. 16 is a cross-sectional view of the semiconductor device receiving apparatus shown in FIG. 14, seen from an arrow B direction;

FIG. 17 is a detailed view of a first example of a part shown by a dotted line L in FIG. 14;

FIG. 18 is a detailed view of a second example of the part shown by the dotted line L in FIG. 14;

FIG. 19 is a perspective view showing detailed structure of a first example of a carrier tape expanding mechanism part;

FIG. 20 is a cross-sectional view showing the detailed structure of the first example of the carrier tape expanding mechanism part;

FIG. 21 is a cross-sectional view showing a modification of the first example of the carrier tape expanding mechanism part;

FIG. 22 is a perspective view of the semiconductor device receiving apparatus and shows a detailed structure of a second example of the carrier tape expanding mechanism part;

FIG. 23 is a cross-sectional view showing the semiconductor device receiving apparatus shown in FIG. 22;

FIG. 24 is a cross-sectional view showing a first modification of the second example of the carrier tape expanding mechanism part;

FIG. 25 is a cross-sectional view showing a second modification of the second example of the carrier tape expanding mechanism part;

FIG. 26 is a cross-sectional view showing a third modification of the second example of the carrier tape expanding mechanism part;

FIG. 27 is plan view of a carrier tape of a first modification of the carrier tape shown in FIG. 7;

FIG. 28 is a perspective view showing a state where the carrier tape shown in FIG. 27 is expanded;

FIG. 29 is a perspective view of a carrier tape of a second modification of the carrier tape shown in FIG. 7;

FIG. 30 is a perspective view showing a state where the carrier tape shown in FIG. 29 is expanded; and

FIG. 31 is a perspective view showing an internal structure of a semiconductor device receiving apparatus wherein the way of winding the carrier tape is different from the way of winding the carrier tape in the semiconductor device receiving apparatus shown in FIG. 4.

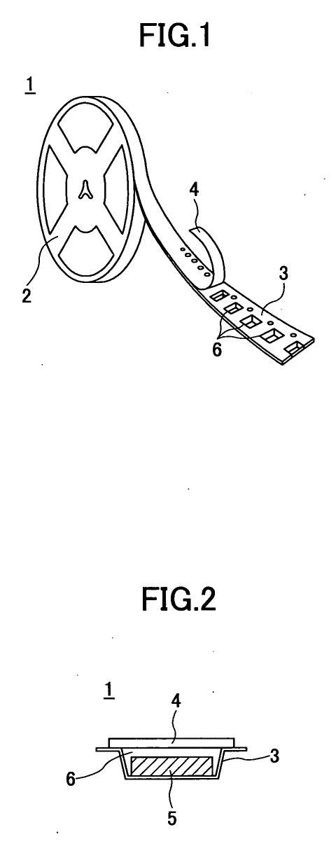

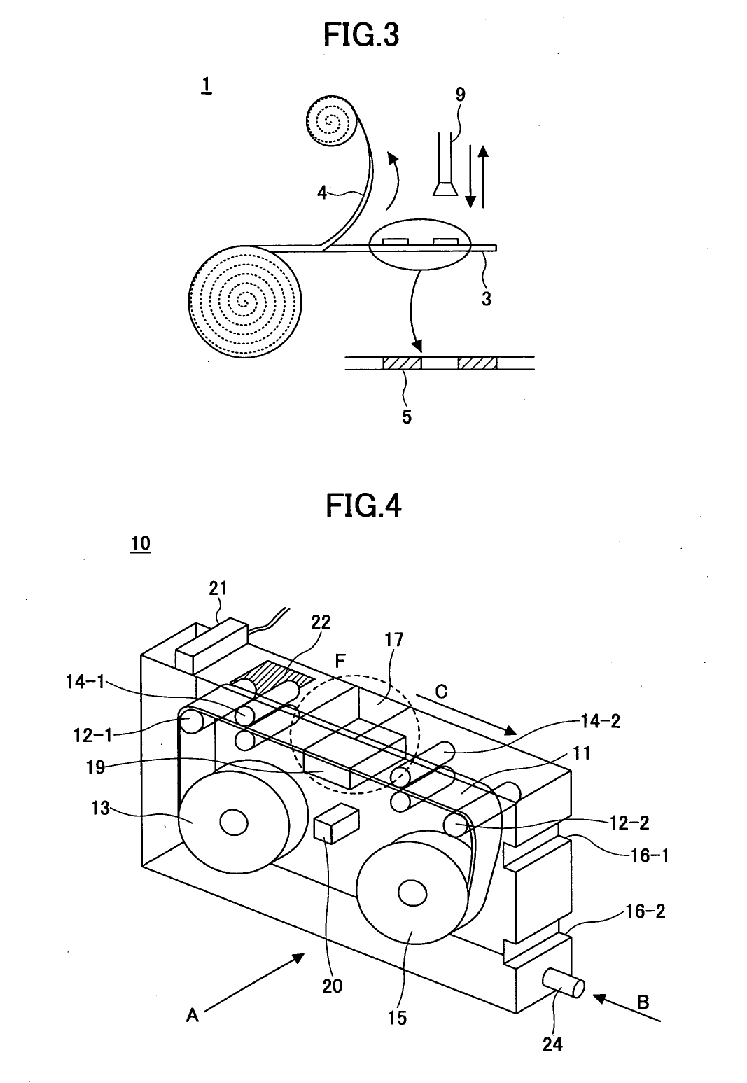

### DETAILED DESCRIPTION OF THE PREFERRED EMBODIMENTS

A description is given below, with reference to the FIG. 4 through FIG. 31 of embodiments of the present invention.

First, an embodiment of an electronic device receiving apparatus of the present invention is discussed. While a semiconductor device receiving apparatus is discussed as an example of the electronic device receiving apparatus in the following explanation, the present invention is not limited to this. The present invention can be applied to a receiving apparatus of an electronic device other than the semiconductor device.

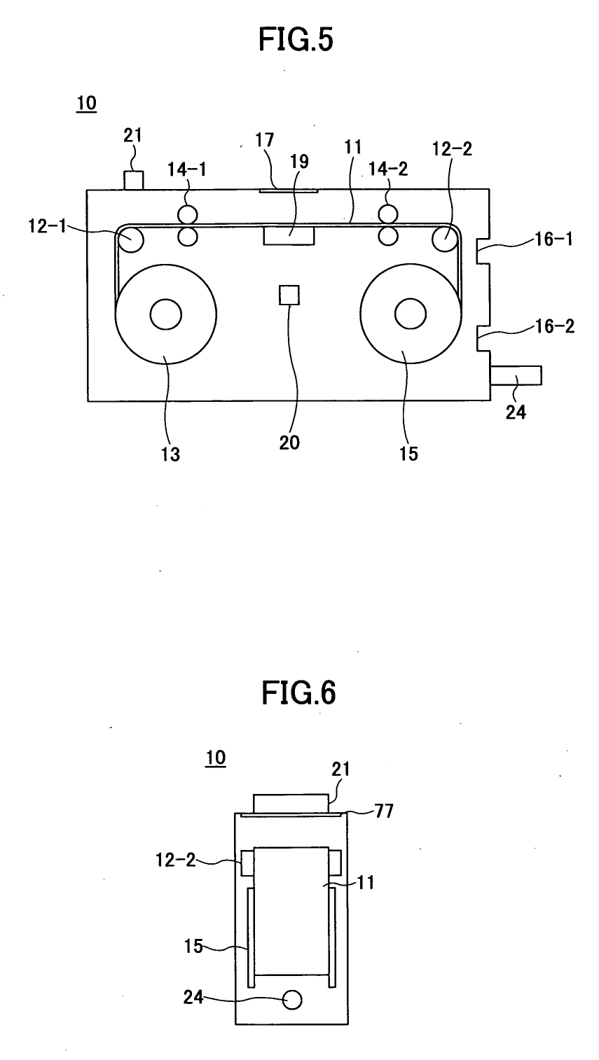

FIG. 4 is a perspective view of a semiconductor device receiving apparatus of an embodiment of the present invention and shows an internal structure of the semiconductor device receiving apparatus. FIG. 5 is a cross-sectional view of the semiconductor device receiving apparatus shown in FIG. 4, seen in an arrow A direction. FIG. 6 is a cross-sectional view of the semiconductor device receiving apparatus shown in FIG. 4, seen in an arrow B direction. For the convenience of explanation, illustration of a detailed structure of a carrier tape, an opening and closing mechanism at an opening part for loading/unloading, and an extending mechanism of the carrier tape, discussed below, are omitted in FIG. 4 through FIG. 6.

Referring to FIG. 4 through FIG. 6, a semiconductor device receiving apparatus 10 having a substantially rectangular parallelepiped-shaped configuration has a sealed structure. A carrier tape 11, a first reel 13, a second reel 15, an opening part 17 for loading/unloading, and others are provided inside the semiconductor device receiving apparatus 10.

A semiconductor device can be placed in the carrier tape 11 so that the semiconductor device can be loaded in or unloaded from the carrier tape 11. Through the opening part 17 for loading/unloading, it is possible to insert the semiconductor device from the outside of the semiconductor device receiving apparatus 10 onto the carrier tape 11 and take out the semiconductor device from the carrier tape 11 to the outside of the semiconductor device receiving apparatus 10.

In a case where the carrier tape 11 runs in a direction shown by an arrow C in FIG. 4, the first reel 13 corresponds to a supply reel of the carrier tape 11 and the second reel 15 corresponds to a winding reel of the carrier tape 11.

In a case where the carrier tape 11 runs in the direction opposite to the direction shown by an arrow C in FIG. 4, the second reel 15 corresponds to the supply reel of the carrier tape 11 and the first reel 13 corresponds to the winding reel of the carrier tape 11.

While a single carrier tape 11, a single first reel 13, and a single second reel 15 are provided in the semiconductor device receiving apparatus 10 in the example shown in FIG. 4 though FIG. 6, the present invention is not limited to this. Plural carrier tapes 11, and plural first reels 13 and plural second reels 15 which correspond to the carrier tapes 11 may be provided in a single semiconductor device receiving apparatus 10.

In addition, large rollers 12-1 and 12-2 configured to change the running direction of the carrier tape 11 by approximately 90 degrees are provided between the first reel 13 and the second reel 15 inside the semiconductor device receiving apparatus 10. Small roller couples 14-1 and 14-2 are provided between the large rollers 12-1 and 12-2, so that the carrier tape 11 is put between the small roller couples 14-1 and 14-2 and runs at a designated pitch.

The first reel 13, second reel 15, large rollers 12-1 and 12-2 and small roller couples 14-1 and 14-2 are made of, for example, metal, polycarbonate (PC) resin, poly phenylene ether (PPE) resin, polypropylene (PP) resin or polysulfone (PSU) resin and have heat-resisting properties.

Sprockets may be used for running the carrier tape 11. In other words, the sprockets may be provided at upper and lower parts or right and left parts of the carrier tape 11 so that the carrier tape 11 can be put between the sprockets, and the carrier tape 11 may be run at a constant pitch by inserting pins of the sprockets into holes formed in the carrier tape 11 and by rotating the sprocket. Metal or resin is selected as material of the sprockets.

A carrier tape extending mechanism part 19 discussed below is provided in the vicinity of edge parts of both sides of the carrier tape 11 so as to face the opening part 17 for loading/unloading, so that the carrier tape 11 is put between the opening part 17 for loading/unloading and the carrier tape extending mechanism part 19.

In addition, a first sensor 20 is provided below the carrier tape 11 and the opening part 17 for loading/unloading. Whether the semiconductor device is received in the carrier tape 11 is detected by the first sensor 20, and thereby timing for opening and closing the opening part 17 for loading/unloading can be determined.

As shown in FIG. 4, a transparent window 22 is provided in the vicinity of the opening part 17 for loading/unloading of an upper surface of the semiconductor device receiving apparatus 10. Through the window 22, it is possible to determine the receiving status of the semiconductor device in the carrier tape 11 by visual observation from the outside of the semiconductor device receiving apparatus 10.

In addition, a second sensor 21 is provided in the vicinity of the window 22 of the upper surface of the semiconductor device receiving apparatus 10. Whether the semiconductor device is received in the carrier tape 11 is detected by the second sensor 21 via the transparent window 22, and thereby timing for opening and closing the opening part 17 for loading/unloading can be determined.

A gas inflow part 24 is provided at a lower part of a surface of the semiconductor device receiving apparatus 10 seen in a direction shown by an arrow B in FIG. 4 so that the inside of the semiconductor device receiving apparatus 10 is filled up with gas.

As discussed above, the semiconductor device receiving apparatus 10 has a sealed structure. Pressure inside the semiconductor device receiving apparatus 10 is kept at more than 1 atmosphere (absolute pressure) by continually filling up with gas from the gas inflow part 24 during the use of the semiconductor device receiving apparatus 10. As a result of this, even with the opening and closing operation of the opening part 17, it is possible to prevent dust or foreign particles from coming into the semiconductor device receiving apparatus 10 from the outside. It is possible to easily obtain a desirable clean atmosphere by using inactive gas such as nitrogen or helium, and thereby it is possible to prevent oxidation and color change of an electrode and others of the semiconductor devices. inserted in the carrier tape 11.

Groove forming parts 16-1 and 16-2 are formed in the surface of the semiconductor device receiving apparatus 10 seen in the direction shown by the arrow B in FIG. 4. It is possible to easily attach the semiconductor device receiving apparatus 10 to other equipment by the groove forming parts 16-1 and 16-2.

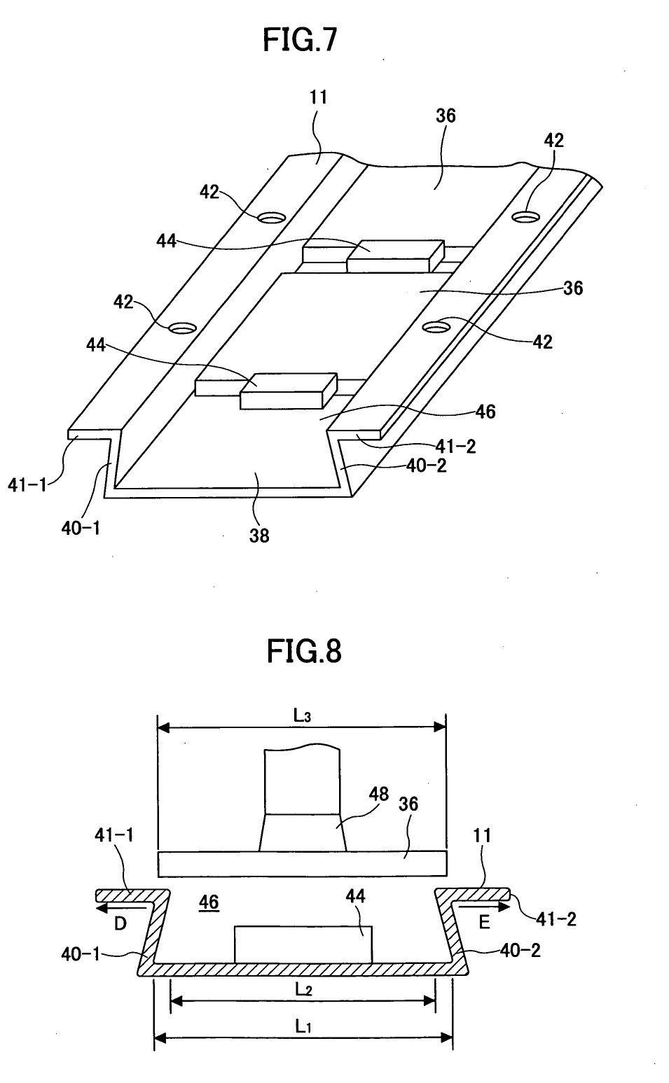

Next, a structure of the carrier tape 11 where the semiconductor device can be loaded or unloaded, the carrier tape 11 being provided inside of the above-mentioned semiconductor device receiving apparatus 10, is discussed with reference to FIG. 7 and FIG. 8. Here, FIG. 7 is a perspective view of the carrier tape 11 and FIG. 8 is a cross-sectional view-of the carrier tape 11.

An embossed tape, for example, can be used as the carrier tape 11. The carrier tape 11 is made of material having a heat-resistance property such as metal, polycarbonate (PC) resin, poly phenylene ether (PPE) resin, and polypropylene (PP) resin.

Referring to FIG. 7, the carrier tape 11 includes plural element receiving parts 38, side walls 40-1 and 40-2, and top part walls 41-1 and 41-2. A semiconductor device 36 is received in the element receiving part 38. The side walls 40-1 and 40-2 project upward from corresponding side edges of the element receiving part 38. The top side walls 40-1 and 40-2 form an opening part 46.

The top side walls 40-1 and 40-2 are formed horizontally from top parts of the side walls 40-1 and 40-2 and also extend in parallel with the element receiving part 38 and in a direction of the length of the carrier tape 11. Holes 42 are provided in a line in each of the top part walls 41-1 and 41-2. By inserting pins or the like into the hole 42, the carrier tape 11 can be moved (run) and elastically extended in the horizontal direction perpendicular to a moving (running) direction of the carrier tape 11. Furthermore, projections 44 are arranged with a constant pitch between the element receiving parts 38 where the semiconductor devices 36 are received.

Referring to FIG. 8, the element receiving part 38 is substantially flat. The side walls 40-1 and 40-2 are inclined so that a gap between the side walls 40-1 and 40-2 is narrower as the side walls 40-1 and 40-2 are separated from the bottom wall 38 upward. Therefore, a length L1 of a gap between the side walls 40-1 and 40-2 at the bottom part, namely a part where the side walls 40-1 and 40-2 connect to the element receiving part 38 is greater than the length of a gap between the side walls 40-1 and 40-2 at a part positioned upward from the element receiving part 38. The length of a gap between the side walls 40-1 and 40-2 at the top parts of the side walls 40-1 and 40-2 is indicated as a length L2 in FIG. 8. Furthermore, the length of the gap between the side walls 40-1 and 40-2 at the part positioned upward from the element receiving part 38 is less than a length L3 of a dimension of the semiconductor device 36 to be received.

Therefore, when the semiconductor device 36 is received in the carrier tape 11 by using, for example, an adhesion head 48, the side walls 40-1 and 40-2 are elastically extended in directions shown by arrows D and E, respectively, and the semiconductor device 36 is inserted from an upper part of the opening part 46 of the top part walls 41-1 and 41-2, so that the semiconductor device 36 is placed on the element receiving part 38.

When the semiconductor device 36 is placed on the element receiving part 38, the side walls 40-1 and 40-2 are returned to their original positions by respective internal elastic forces. As a result of this, the side walls 40-1 and 40-2 come in contact with the semiconductor device 36 so that a part of the semiconductor device 36 is covered with the side walls 40-1 and 40-2 and thereby the semiconductor device 36 is held in the carrier tape 11 by elastic force.

In the example shown in FIG. 7, the element receiving parts 38 formed by the side walls 40-1 and 40-2 and the projections 44 are arranged in the length direction of the carrier tape 11 formed in a line. However, the present invention is not limited to this. Plural lines of the element receiving parts 38 may be formed in a width direction of the carrier tape 11.

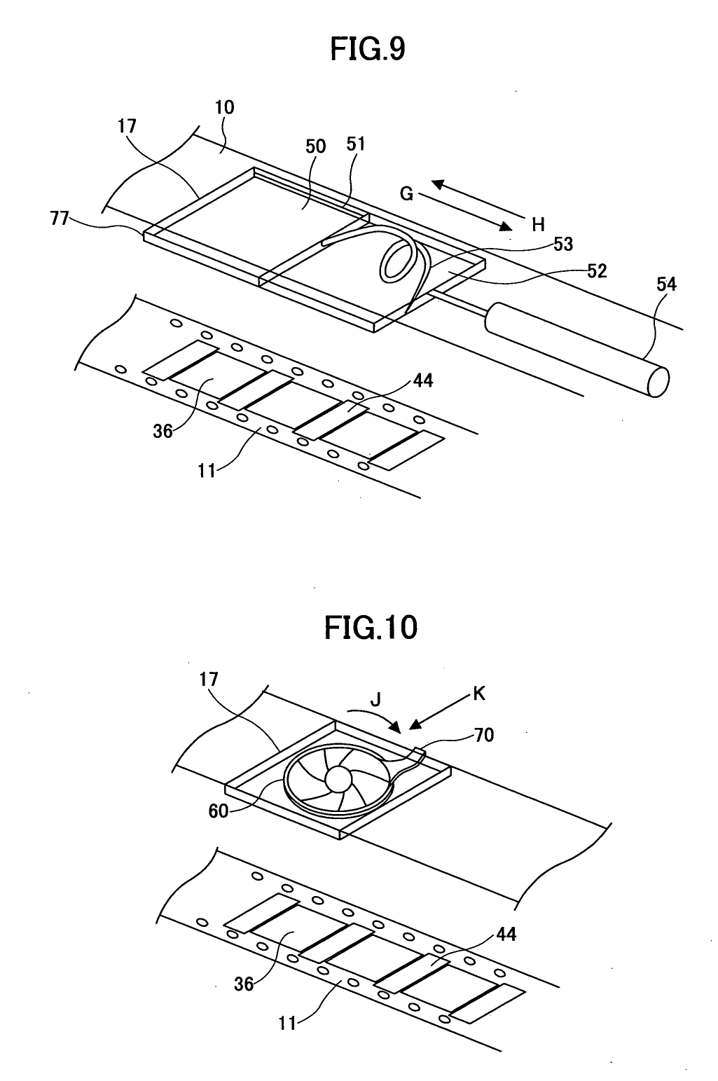

Next, the opening and closing mechanism of the opening part 17 for loading/unloading is discussed with reference to FIG. 9 through FIG. 18. FIG. 9 is a detailed perspective view showing a first example of a part shown by a broken line F in FIG. 4.

As shown in FIG. 4 and FIG. 9, the opening part 17 for loading/unloading is provided above the carrier tape 11 and inside of the semiconductor device receiving apparatus 10.

As shown in FIG. 9, an opening part 50 of an upper surface of the opening part 17 for loading/unloading is positioned at the upper surface of the semiconductor device receiving apparatus 10. The semiconductor device receiving apparatus 10 is opened by opening the opening part 50. A groove 51 is formed at an internal edge part of the opening part 50 in a direction shown by an arrow G(H). In addition, a first door 52 is provided slidably along the groove 51 and in the direction shown by the arrow G(H).

The first door 52 is made of, for example, metal, polycarbonate (PC) resin, poly phenylene ether (PPE) resin, polypropylene (PP) resin or polysulfone (PSU) resin and has heat-resisting properties.

A coil spring 53 is arranged inside of the first door 52. The first door 52 is connected to an air cylinder 54 provided inside of the semiconductor device receiving part 10.

The first door 52 is slid from the opening part 50 of the opening part 17 for loading/unloading in the direction shown by the arrow G in FIG. 9. In other words, the first door 52 is positioned at the opening part 50 by a spring force of the coil spring 53, the air cylinder 54 is operated in a state where the opening part 17 for loading/unloading is closed, and the first door 52 is slid from the opening part 50 in the direction shown by the arrow G in the same plane surface. As a result of this, the opening 17 for loading/unloading can be opened.

Then, the first door 52 is slid in the direction shown by the arrow H and positioned at the opening part 50, so that the opening part 17 for loading/unloading can be closed.

Thus, in this embodiment, the opening part 17 for loading/unloading can be opened and closed by the first door 52 so that the semiconductor device 36 can be loaded to and unloaded from the element receiving part 38 of the carrier tape 11 provided inside of the semiconductor device receiving apparatus 10.

Only the opening part 50 of the opening part 17 for loading/unloading may be opened for such a loading/unloading operation and therefore sealability of the semiconductor device receiving apparatus 10 can be secured.

In addition, the first door 52 is slid in a horizontal direction, namely the direction shown by the arrow G or H. Therefore, the area of the opening 17 for loading/unloading can be made smaller than in a case where the opening and closing operation of the opening part 17 for loading/unloading can be performed by rotating the first door 52. Hence, it is possible to make the size of the semiconductor device receiving apparatus 10 small and to ensure the sealability of the semiconductor device receiving apparatus 10.

The structure of the opening part 17 for loading/unloading is not limited to the example shown in FIG. 9 but may be according to an example shown in FIG. 10 through FIG. 14.

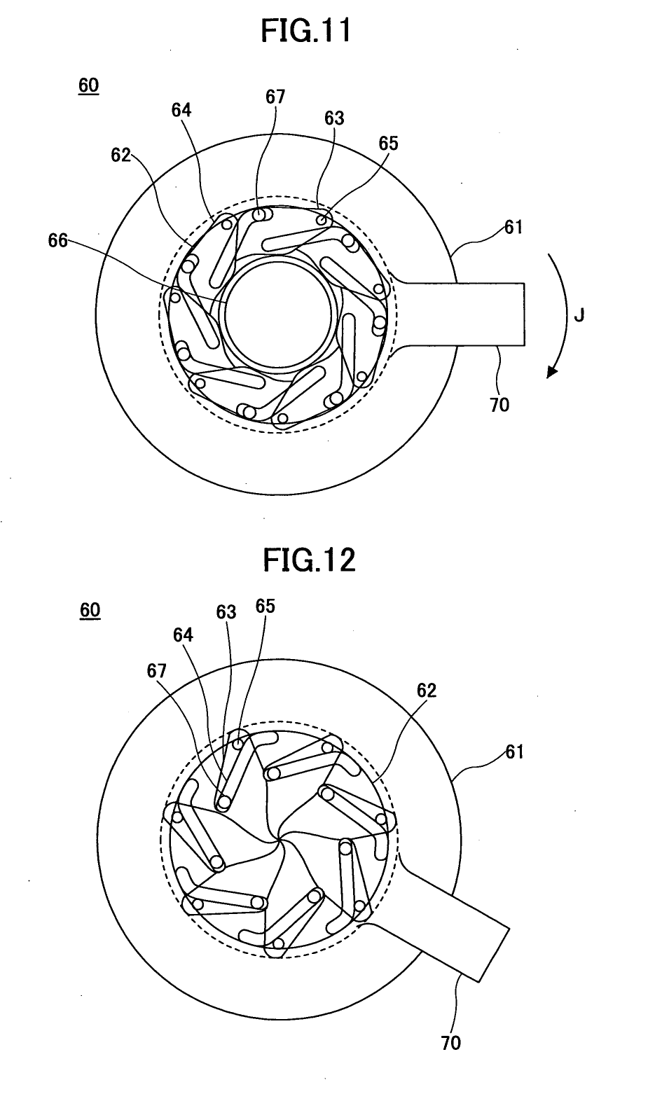

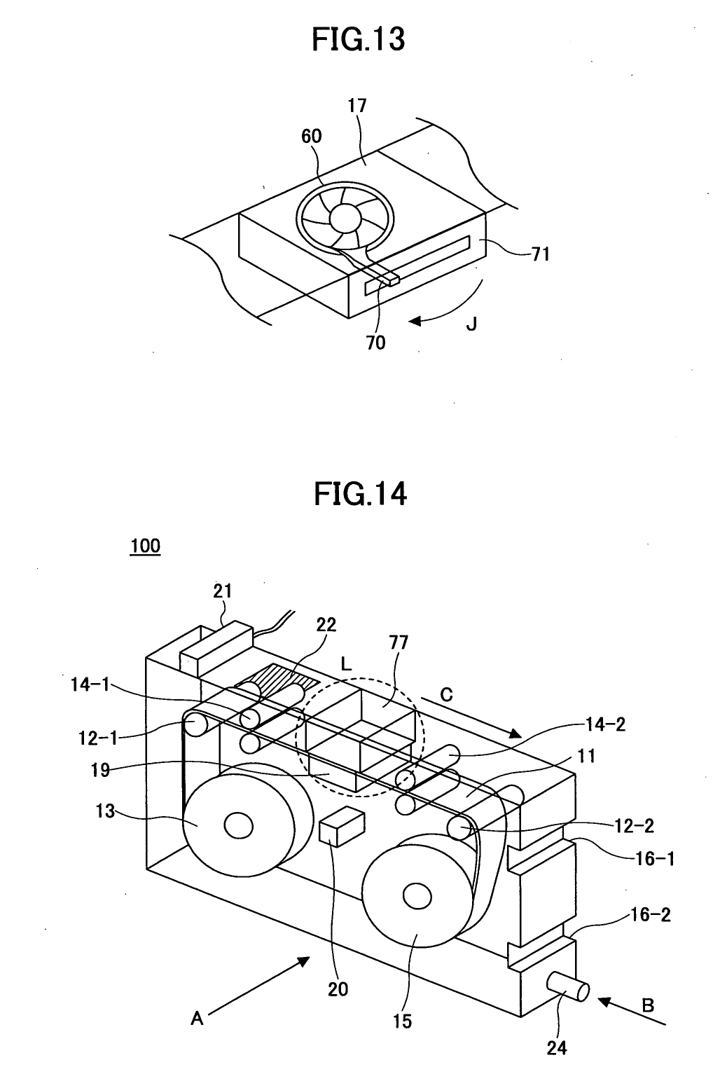

FIG. 10 is a detailed perspective view showing a second example of the part shown by the broken line F in FIG. 4. FIG. 11 is a plan view (part 1) of a first aperture mechanism body 60 shown in FIG. 10 and shows a state where the opening part 17 for loading/unloading is opened. FIG. 12 is a plan view (part 2) of the first aperture mechanism body 60 shown in FIG. 10 and shows a state where the opening part 17 for loading/unloading is closed. FIG. 13 is a perspective view of the opening part 17 for loading/unloading shown in FIG. 10, seen from an arrow K direction.

A first aperture mechanism body 60, instead of the first door 52 shown in FIG. 9, is provided in an example shown in FIG. 10. An upper surface of the first aperture mechanism body 60 is positioned at an upper surface of the semiconductor device receiving apparatus 10. The semiconductor device receiving apparatus 10 can be opened by opening the first aperture mechanism body 60.

The first aperture mechanism body 60 is made of, for example, metal, polycarbonate (PC) resin, poly phenylene ether (PPE) resin, polypropylene (PP) resin or polysulfone (PSU) resin and has heat-resisting properties.

Referring to FIG. 11 and FIG. 12, the first aperture mechanism body 60 includes circular shaped base 61, plural (seven in this example) aperture wings 63, a rotating member 70, and others. The aperture wing 63 can be rotated against the base 61 by the rotating member 70.

The aperture wing 63 has a substantially diamond-shaped configuration. A supporting pin 65 projects from an end part of the aperture wing 63. An engaging pin 67 projects at a part of the aperture wing 63 separated from the support pin 65 at a designated length. Each of the aperture wings 63 has the same structure and is formed on a substantially same surface.

The aperture wing 63 is rotatably supported against the base 61 by inserting the supporting pin 65 into a supporting hole (not shown) of the base 61. The aperture wing 63 is guided along a cam groove 64 by inserting the engaging pin 67 into the cam groove 64 formed in the rotating ring 62.

As shown in FIG. 11, plural aperture wings 63 are positioned and form a ring shape where parts of the aperture wings are overlapped. In FIG. 11, the opening part 66 is opened.

On the other hand, the engaging pins 67 move in the corresponding cam grooves 64 by rotating the rotating member 70 in the direction shown by the arrow J in FIG. 11 from the open state shown in FIG. 11, and rotating the rotating ring 62 in the same direction. As a result of this, the aperture wings 63 are rotated in a direction opposite to the direction shown by the arrow J in FIG. 10, FIG. 11 and FIG. 13 in the substantially same plane surface so that the opening part 66 is closed as shown in FIG. 12.

In order to open the opening part 66 again, the rotating member 70 is rotated in a direction opposite to the direction shown by the arrow J in FIG. 10, FIG. 11 and FIG. 13.

Referring to FIG. 13, the rotating member 70 projects from a rotating member groove 71 formed on a side surface of the opening 17 for loading/unloading. The rotating member 70 can be operated manually at an outside of the semiconductor device apparatus 10.

Thus, in this example, the opening part 17 for loading/unloading can be opened and closed by the first aperture mechanism body 60 so that the loading and unloading operation of the semiconductor device 36 shown in FIG. 7 and others in the carrier tape 11 provided in the inside of the semiconductor device receiving apparatus 10 can be operated. For this operation, namely, the loading and unloading operation of the semiconductor device 36 in the carrier tape 11 provided inside the semiconductor device receiving apparatus 10, only the first aperture mechanism body 60 may be opened and it is possible to keep and ensure the sealability of the semiconductor device receiving apparatus 10.

In addition, the aperture wings 63 of the first aperture mechanism body 60 are rotated in the same plane surface. Therefore, as compared a case where the first door 52 (See FIG. 9) is rotated so as to be positioned in a direction perpendicular to the direction shown by the arrow G or H and thereby the opening 17 for loading/unloading is opened and closed, it is possible to make the opening part 17 for loading/unloading small and the size of the semiconductor device receiving apparatus 10 can be made small.

In the meantime, in this example, the rotating member 70 is operated manually at the outside of the semiconductor device apparatus 10 so that the aperture wings 63 are rotated. However, the present invention is not limited to this. For example, a force may be applied from outside the semiconductor device receiving apparatus 10, and the force may be mechanically converted inside the semiconductor device receiving apparatus 10 so that the aperture wings 63 can be rotated.

In addition, in the examples shown in FIG. 4 through FIG. 6 and FIG. 9 through FIG. 13, a single door 52 or a single aperture mechanism body 60 is provided at the opening part 50 of the upper surface of the opening 17 for loading/unloading. However, the present invention is not limited to these structures. Plural doors or plural aperture mechanisms may be provided.

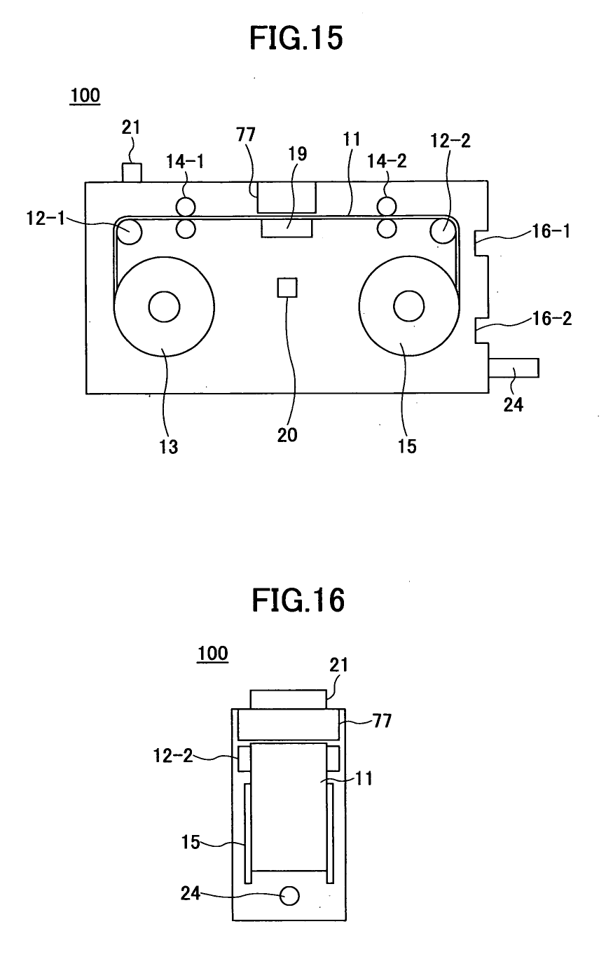

FIG. 14 is a schematic perspective view showing an internal structure of a semiconductor device receiving apparatus having an opening part for loading/unloading different from the opening part 17 for loading/unloading of the semiconductor device receiving apparatus shown in FIG. 4. FIG. 15 is a cross-sectional view of the semiconductor device receiving apparatus shown in FIG. 14, seen from an arrow A direction. FIG. 16 is a cross-sectional view of the semiconductor device receiving apparatus shown in FIG. 14, seen from an arrow B direction. In FIG. 14 through FIG. 16, parts that are the same as the parts shown in FIG. 4 through FIG. 6 are given the same reference numerals, and explanation thereof is omitted.

Referring to FIG. 14 through FIG. 16, a semiconductor device receiving apparatus 100, as well as the above-discussed semiconductor device receiving apparatus, having a substantially rectangular parallelepiped-shaped configuration, has a sealed structure. The semiconductor device receiving apparatus 10 has an opening part 77 for loading/unloading.

Through the opening part 77 for loading/unloading, it is possible to insert the semiconductor device from outside the semiconductor device receiving apparatus 100 onto an element receiving part 38 of the carrier tape 11 and take out the semiconductor device from the element receiving part 38 of the carrier tape 11 to the outside of the semiconductor device receiving apparatus 100.

An upper surface of the opening part 77 for loading/unloading is positioned at an upper external surface of the semiconductor device receiving apparatus 10. A lower surface of opening part 77 for loading/unloading is positioned above the carrier tape 11 with a slight gap.

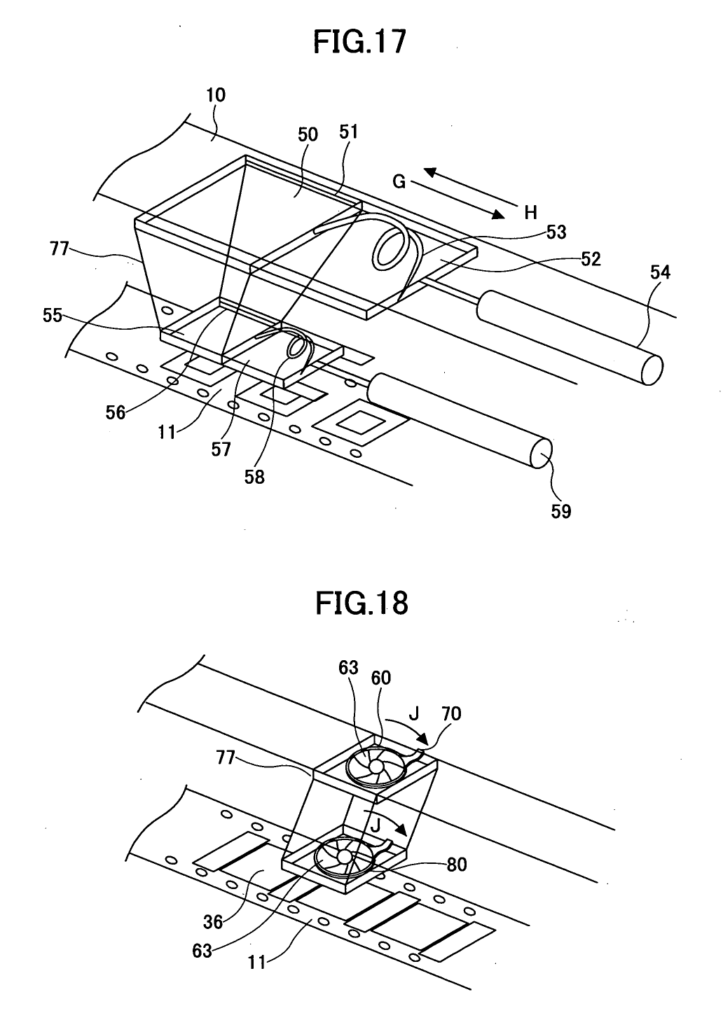

FIG. 17 is a detailed perspective view of a first example of a part shown by a broken line L in FIG. 14.

Referring to FIG. 17, the groove 51 is formed at an internal edge part of the opening part 50 provided at an upper part of the opening part 17 for loading/unloading, in a direction shown by an arrow G(H). In addition, the first door 52 is provided slidably along the groove 51 and in the direction shown by the arrow G(H). The coil spring 53 is arranged inside of the first door 52. The first door 52 is connected to the air cylinder 54 provided inside of the semiconductor device receiving part 10.

In addition, a groove 56 is formed at an internal edge part of an opening part 55 provided at a lower part of the opening part 77 for loading/unloading, in a direction shown by an arrow G(H). In addition, a second door 57 whose material is same as the material of the first door 52 is provided slidably along the groove 56 and in the direction shown by the arrow G(H). A coil spring 58 is arranged inside of the second door 57. The second door 57 is connected to an air cylinder 59 provided inside of the semiconductor device receiving part 10.

FIG. 17 shows where the first door 52 is slid from the opening part 50 and the second door 57 is opened from the opening part 55 in the direction shown by the arrow G.

In other words, the air cylinder 54 is operated, where the first door 52 is positioned at the opening part 50 by the spring force of the coil spring 53 so that the opening part 77 for loading/unloading is closed, and thereby the first door 52 is slid from the opening part 50 in the direction shown by the arrow G in the same plane surface. In addition, the air cylinder 59 is operated where the second door 57 is positioned at the opening part 55 by the spring force of the coil spring 58 so that the opening part 77 for loading/unloading is closed, and then the second door 57 is slid from the opening part 50 in the direction shown by the arrow G in the same plane surface. As a result of this, it is possible to open the opening part 77 for loading/unloading.

Furthermore, when the opening part 77 for loading/unloading is closed, the first door 52 and the second door 57 are slid in the direction shown by the arrow H so that the first door 52 is positioned at the opening part 50 and the second door 57 is positioned at the opening part 55.

The structure of the opening part 17 for loading/unloading may be as shown in FIG. 18. Here, FIG. 18 is a detailed perspective view of a second example of the part shown by the broken line L in FIG. 14.

Referring to FIG. 18, a first aperture mechanism body 60 is provided at the upper part of the opening part 77 for loading/unloading. A second aperture mechanism body 80 whose material is same as the material of the first aperture mechanism body 60 is provided at the lower part of the opening part 77 for loading/unloading. It is possible to operate the opening part 77 for loading/unloading by using the first aperture mechanism body 60 and the second aperture mechanism body 80.

As shown in FIG. 17 and FIG. 18, the second door 57 (See FIG. 17) or the second aperture mechanism body 80 (See FIG. 18) is provided at the lower surface of the opening part 77 for loading/unloading provided above the carrier tape 11 with a gap. In addition, in a case where the semiconductor device is picked up from the element receiving part 38 of the carrier tape 11 by using the adhesion jig 9, after the semiconductor device is pulled out from the carrier tape 11 by the adhesion jig 9, the second door 57 or the second aperture mechanism body 80 provided at the lower surface of the opening part 77 is closed, the adhesion jig 9 is further raised so that the semiconductor device is taken out from the semiconductor device receiving apparatus 100, and then the first door 52 (See FIG. 17) or the first aperture mechanism body 60 (See FIG. 18) provided at the upper surface of the opening part 77 for loading/unloading is closed.

Therefore, as compared with a case shown in FIG. 9 or FIG. 10 where the door 52 or the aperture mechanism body 60 is provided at only the upper surface of the opening part 77 for loading/unloading, reduction of the pressure inside of the semiconductor device receiving apparatus 100 at the time when the opening part 77 for loading/unloading is opened or closed can be better alleviated. In addition, the consumption amount of gas flowing from the gas inflow part 24 is reduced. Therefore, it is possible to secure the sealability of the inside of the semiconductor device receiving apparatus 100.

Furthermore, in the example shown in FIG. 17, the first door 52 and the second door 57 are slid in the horizontal direction. In the example shown in FIG. 18, the aperture wings 63 of the first aperture mechanism body 60 and the second aperture mechanism body 80 are rotated on the same plane surface. Therefore, as compared with a case where the opening part 77 for loading/unloading is opened and closed by rotating the first door 52 and the second door 57 so that the first door 52 and the second door 57 are positioned in a direction perpendicular to the direction shown by the arrow G(H) in FIG. 17, it is possible to make the size of the opening part 77 for loading/unloading smaller so that the size of the semiconductor device receiving apparatus 100 can be made smaller.

In the meantime, the first sensor 20 is provided below the carrier tape extending mechanism part 19 facing the opening part 17 via the carrier tape 11. The second sensor 21 is provided in the vicinity of the transparent window 22 provided in the vicinity of the opening part 17(77) of the upper surface of the semiconductor device receiving apparatus 10(100). The first sensor 20, the second sensor 21, or the window 22 functions as a detection part.

Therefore, whether the semiconductor device is received in the element receiving part of the carrier tape 11 is detected by the detection part, and thereby timing for opening and closing the opening part 17(77) for loading/unloading can be determined.

Hence, when the semiconductor device is picked up from the element receiving part 38 of the carrier tape 11, whether there is an error of the picking-up operation of the semiconductor device and whether the semiconductor device is received in the element receiving part 38 of the carrier tape 11, can be easily determined. Thus, it is possible to improve an operability of the picking-up process of the semiconductor device.

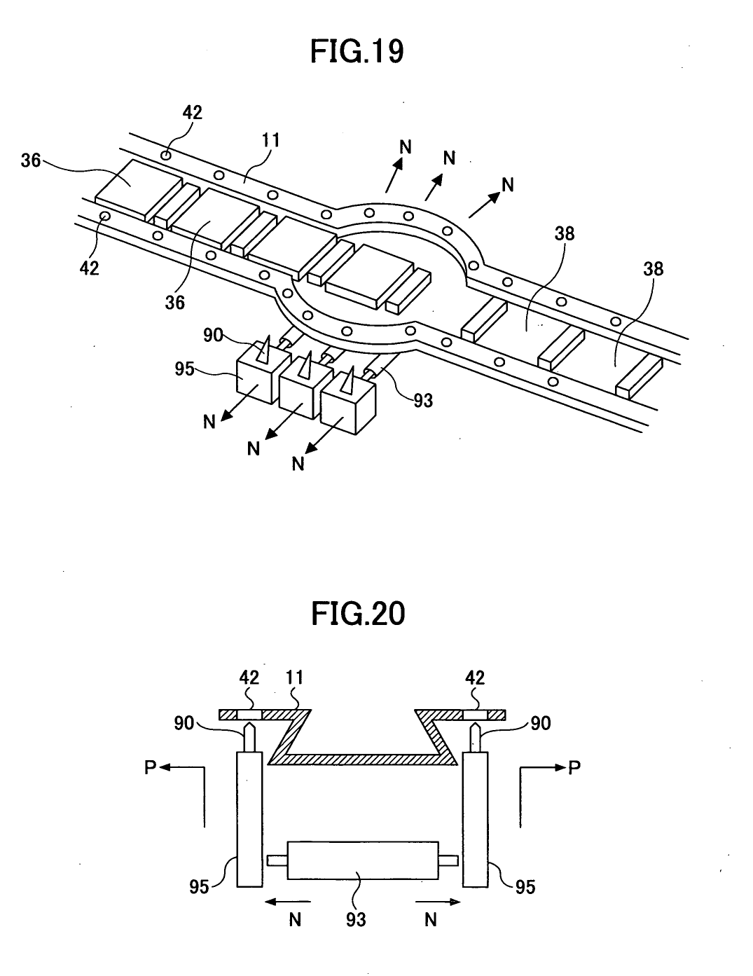

Next, a mechanism for expanding the carrier tape 11 is discussed with reference to FIG. 19 through FIG. 30.

As discussed above with reference to FIG. 8, in order to load and unload the semiconductor device 36 against the element receiving part 38 of the carrier tape 11, it is necessary to elastically extend the wide walls 40-1 and 40-2 in the directions shown by the arrows D and E.

FIG. 19 is a perspective view showing the detailed structure of a first example of a carrier tape expanding mechanism part 19. FIG. 20 is a cross-sectional view showing the detailed structure of the first example of the carrier tape expanding mechanism part 19.

In structures shown in FIG. 19 and FIG. 20, as an extending mechanism of the carrier tape 11, plural jigs 95 having pins and an air cylinder 93 being a moving member of the jigs 95 are used. Plural jigs 95 face each other via the carrier tape 11 so that the carrier tape 11 can be extending in the width direction of the carrier tape 11. The jigs 95 can be moved in a direction substantially perpendicular to the moving (running) direction of the carrier tape 11.

The jig 95 is made of, for example, metal, polycarbonate (PC) resin, poly phenylene ether (PPE) resin, polypropylene (PP) resin or polysulfone (PSU) resin and has heat-resisting properties. The pin projects on the upper surface of the jig 95 and can be moved upward and downward.

The pin 90 rises so as to be inserted in the hole 42 of the carrier tape 11 and project from the upper surface of the carrier tape 11. In this state, the jig 95 is moved in the direction shown by arrows N by the air cylinder 93 so that the carrier tape 11 is elastically extended in the directions shown by the arrows N and the semiconductor device can be loaded and unloaded against the element receiving part 38 of the carrier tape 11.

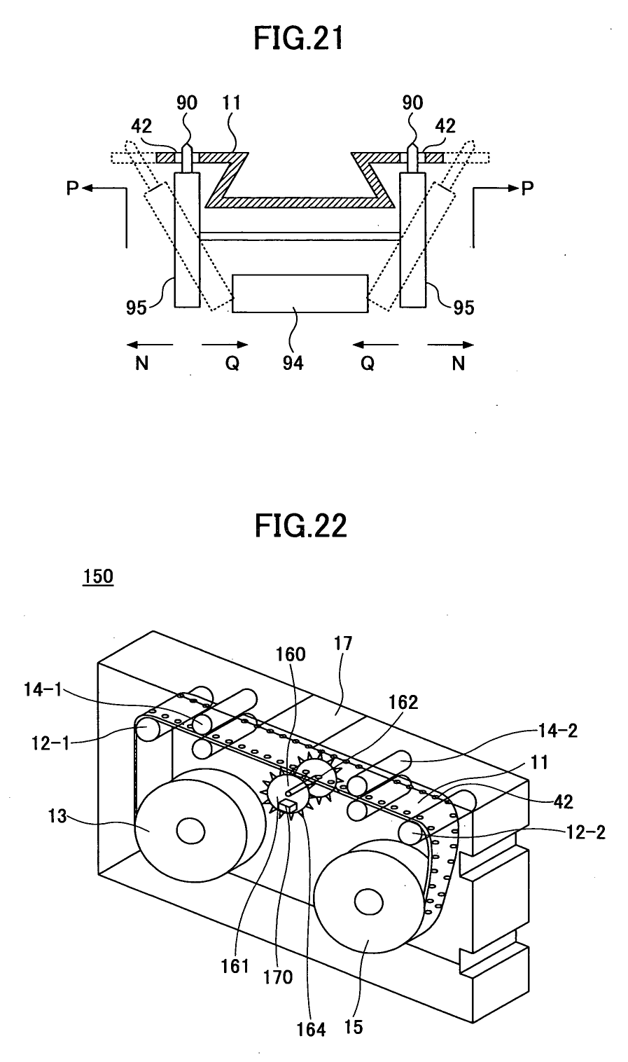

While the jigs 95 having the pin 90 is moved in the direction shown by the arrows N by the air cylinder 93 in the examples shown in FIG. 19 and FIG. 20, the present invention is not limited to this. For example, a structure shown in FIG. 21 can be used. Here, FIG. 21 is a cross-sectional view showing a modification of the first example of the carrier tape expanding mechanism part 19.

In the modification shown in FIG. 21, an electromagnet 94 is used as the moving means of the jigs 95 in the carrier tape extending mechanism. A lower part of each of the jigs 95 having the pin 90 is moved in the direction shown by the corresponding arrow Q by a magnetic force of the electromagnet 94, so that the jigs 95 are inclined. As a result of this, the pin 90 moves in the directions shown by corresponding arrows P in FIG. 21, and thereby the carrier tape 11 is elastically extended in the directions shown by the arrows N and the semiconductor device can be loaded onto and unloaded from the element receiving part 38 of the carrier tape 11.

The extended state of the carrier tape 11 is terminated by stopping the operation of the air cylinder 93 in the example shown in FIG. 20 or the electromagnet 94 in the example shown in FIG. 21, so that the side walls 40-1 and 40-2 of the carrier tape 11 return to thier original positions.

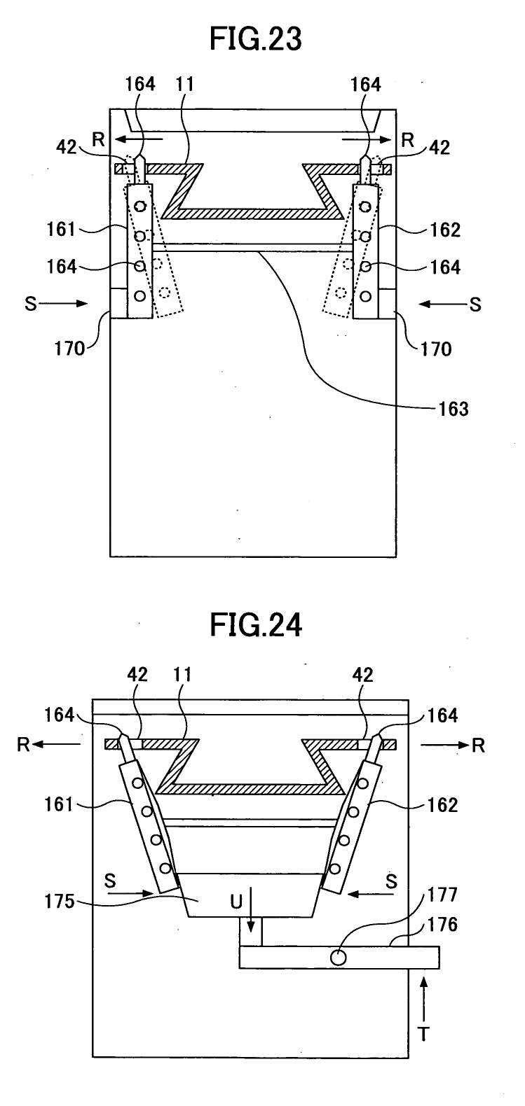

Next, a second example of the carrier tape extending mechanism part 19 in the semiconductor device receiving apparatus shown in FIG. 4 and FIG. 14 is discussed. Here, FIG. 22 is a perspective view of the semiconductor device receiving apparatus and shows a detailed structure of a second example of the carrier tape expanding mechanism part 19. FIG. 23 is a cross-sectional view showing the semiconductor device receiving apparatus shown in FIG. 22.

Illustration of the first sensor 20, the second sensor 21, the window 22, and the gas inflow part 24 provided in the semiconductor device receiving apparatus 10 shown in FIG. 4 are omitted in FIG. 22. In FIG. 22, parts that are the same as the parts shown in FIG. 4 are given the same reference numerals, and explanation thereof is omitted.

Referring to FIG. 22, a sprocket body 160 is used as a carrier tape extending mechanism in the semiconductor device receiving apparatus 150.

The sprocket body 160 is made of, for example, metal, polycarbonate (PC) resin, poly phenylene ether (PPE) resin, polypropylene (PP) resin or polysulfone (PSU) resin and has heat-resisting properties.

Referring to FIG. 23, the sprocket body 160 is formed by connecting disk-shaped sprockets 161 and 162 by a rotational shaft 163. Plural pins are arranged with a constant interval on external circumferential surfaces of the sprockets 161 and 162. The pin 164 is inserted in the hole 42 of the carrier tape 11 and projects from the upper surface of the carrier tape 11.

In addition, de-centering causing parts 170 as the sprocket moving members facing each other via the sprocket body 160 are provided at parts corresponding to the lower parts of the sprockets 161 and 162 and the external side surfaces of the semiconductor device receiving apparatus 150. The de-centering causing part 170 is pushed from the outside of the semiconductor device receiving apparatus 150 as shown by arrows S in FIG. 23, so that pushing forces are transferred to the lower parts of the sprockets 161 and 162 and the sprockets 161 and 162 are inclined as shown by broken lines in FIG. 23. As a result of this, the pin 164 projecting upward from the hole 42 formed in the carrier tape 11 move in the directions shown by the corresponding arrows R and thereby the carrier tape 11 is elastically extended in the directions shown by the arrows R and the semiconductor device can be loaded and unloaded against the carrier tape 11.

FIG. 24 is a cross-sectional view showing a first modification of the second example of the carrier tape expanding mechanism part 19. As shown in FIG. 24, instead of the de-centering causing part 170, a moving member 175 can be used as the sprocket moving member. The moving member 175 is provided between the sprockets 161 and 162 and has a taper part having a desirable angle on side faces whereby the sprockets 161 and 162 are inclined.

As shown in FIG. 24, taper parts side faces are provided at internal side surfaces of the sprockets 161 and 162. The taperer moving member 175 is connected to an end of the rotating member 176. The rotating member 176 extends to the outside of the semiconductor device receiving apparatus 150. The rotating member 176 is rotated in a direction shown by an arrow U with respect to a shaft 177 by applying a force to other end of the rotating member 176 in a direction shown by an arrow T. On the other hand, an external force in a direction shown by an arrow S is applied to external side surfaces of the sprockets 161 and 162.

By such an operation, the moving member 175 is lowered while the taper part of the moving member 175 comes in contact with the taper part of the sprockets 161 and 162. Because of this, the upper parts of the sprockets 161 and 162 are inclined to the outside where the shaft 163 is a center of inclination. As a result of this, the pin 164 projecting upward from the holes 42 formed in the carrier tape 11 move in the corresponding direction shown by the arrows R, and thereby the carrier tape 11 is elastically extended in the direction shown by the arrows R and the semiconductor device can be loaded and unloaded against the element receiving part 38 of the carrier tape 11.

The extended state of the carrier tape 11 is terminated by eliminating the pressing pressure from outside of the de-centering causing part 170 in the example shown in FIG. 23 or operating the rotating member 176 in a direction opposite to the direction shown by an arrow T in the example shown in FIG. 24, so that the side walls 40-1 and 40-2 of the carrier tape 11 are elastically moved back to their original positions.

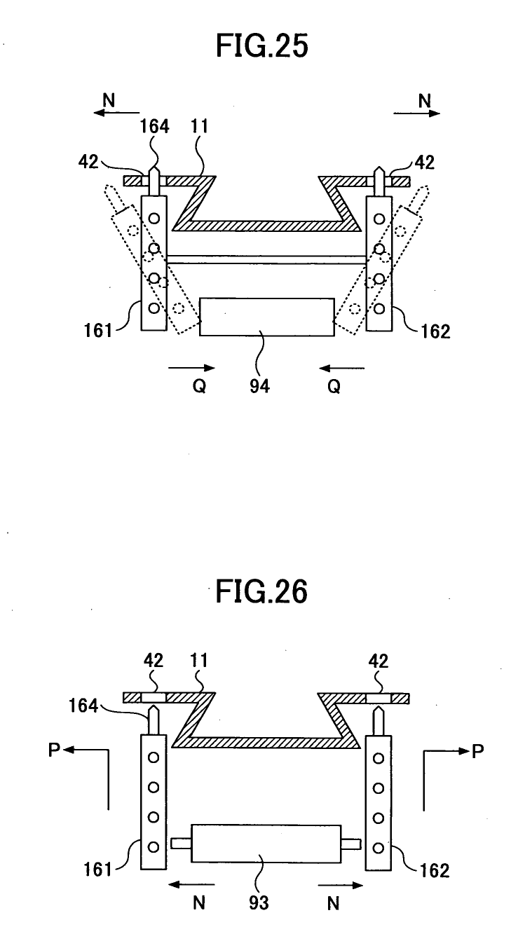

In addition, instead of the structure using the moving member 175 shown in FIG. 24, a structure shown in FIG. 25 or FIG. 26 may be used. Here, FIG. 25 is a cross-sectional view showing a second modification of the second example of the carrier tape expanding mechanism part 19. FIG. 26 is a cross-sectional view showing a third modification of the second example of the carrier tape expanding mechanism part 19.

In the example shown in FIG. 25, the electromagnet 94 is used as the sprocket moving member. Lower parts of the sprockets 161 and 162 are moved in the direction shown by arrows Q by a magnetic force of the electromagnet 94, so that the sprockets 161 and 162 are inclined. As a result of this, the pin 164 projecting upward from the hole 42 formed in the carrier tape 11 moves in the directions shown by arrows N, and thereby the carrier tape 11 is elastically extended in the directions shown by the arrows N and the semiconductor device can be loaded and unloaded against the element receiving part 38 of the carrier tape 11.

In the example shown in FIG. 26, the air cylinder 93 is used as the sprocket moving member. The sprockets 161 and 162 having the pins 164 move in the directions shown by the arrows N by the air cylinder, and thereby the carrier tape 11 is elastically extended in the directions shown by the arrows N and the semiconductor device can be loaded and unloaded against the element receiving part 38 of the carrier tape 11.

An extended state of the carrier tape 11 is turned off by stopping the operation of the electromagnet 94 in the example shown in FIG. 25 and stopping the operation of the air cylinder 93 shown in FIG. 26, so that the side walls 40-1 and 40-2 of the carrier tape 11 are elastically moved back to the original positions.

In the structures shown in FIG. 22 through FIG. 26, the carrier tape 11 is extended in the directions shown by the arrows N by inclining the sprockets 161 and 162. However, the present invention is not limited to this structure.

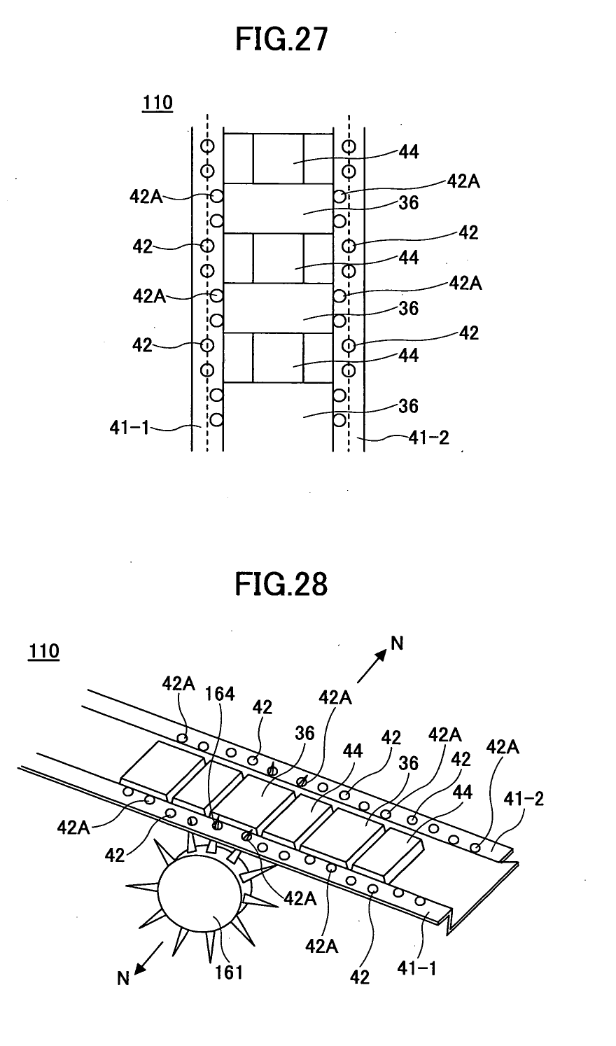

FIG. 27 is plan view of a carrier tape 110 of a first modification of the carrier tape shown in FIG. 7. FIG. 28 is a perspective view showing a state where the carrier tape 110 shown in FIG. 27 is expanded.

Referring to FIG. 27, in the carrier tape 110, holes 42A and holes 42 are formed in the top part walls 41-1 and 41-2. The holes 42A are situated at a part corresponding to the element receiving part 38 put between the projections 44 and close to a side of the element receiving part 38 of the top walls 41-1 and 41-2. On the other hand, holes 42 are situated at a part corresponding to the projections 44 and in the substantially center of the top walls 41-1 and 41-2.

Under this structure, as shown in FIG. 28, when the carrier tape 110 moves above the sprockets 161 and 162, the pins 164 of the sprockets 161 and 162 are inserted in the holes 42A formed as corresponding to the semiconductor device receiving part 36 from a lower side.

The carrier tape 11 is elastically extended in the direction shown by the arrows N by inclination or moving of the sprockets 161 and 162 to the outside, so that the semiconductor device can be loaded and unloaded against the element receiving part 38 of the carrier tape 11.

The extended state of the carrier tape 11 is turned off when the holes 42 provided in the top part walls 41-1 and 41-2 and at the part corresponding to the part where the projections 44 are provided pass above the sprockets 161 and 162, so that the side walls 40-1 and 40-2 of the carrier tape 11 are elastically moved back to the original positions.

Under this structure, two lines of the holes 42 are arranged in parallel with each other in a longitudinal direction of the carrier tape 110. Because of this, pins 164 of the sprockets 161 and 162 are provided as corresponding to common positions of the two lines of the holes 42, namely position overlapped in a width direction of the carrier tape 110. When the pins 164 are inserted into the holes 42A, the top wall parts 41-1 and 41-2 of the carrier tape 110 are extended in the horizontal direction via the holes 42A so that the semiconductor device can be loaded and unloaded against the element receiving part 38.

When the pins 164 are inserted into the holes 42 provided as corresponding to a part where the projection 44 is provided, the extended state of the carrier tape 110 is turned off because the holes 42 are positioned outside of the holes 42A.

In a case where the size of the semiconductor device is large (not illustrated) the holes are continuously provided in the longitudinal direction of the carrier tape in a sine wave pattern and the pins 164 provided at the sprockets 161 and 162 are positioned as corresponding to the holes 42 so that the opening and closing operation of the upper surface of the carrier tape can be done immediately.

In other words, at the side of the element receiving part 38, the hole 42 is provided so as to be close to the element receiving part 38. At a part between the element receiving part 38 and the projection 44, the hole 42 is provided so as to gradually change the distance from the part. Under this structure, it is possible to continuously and immediately open and close the upper surface of the carrier tape.

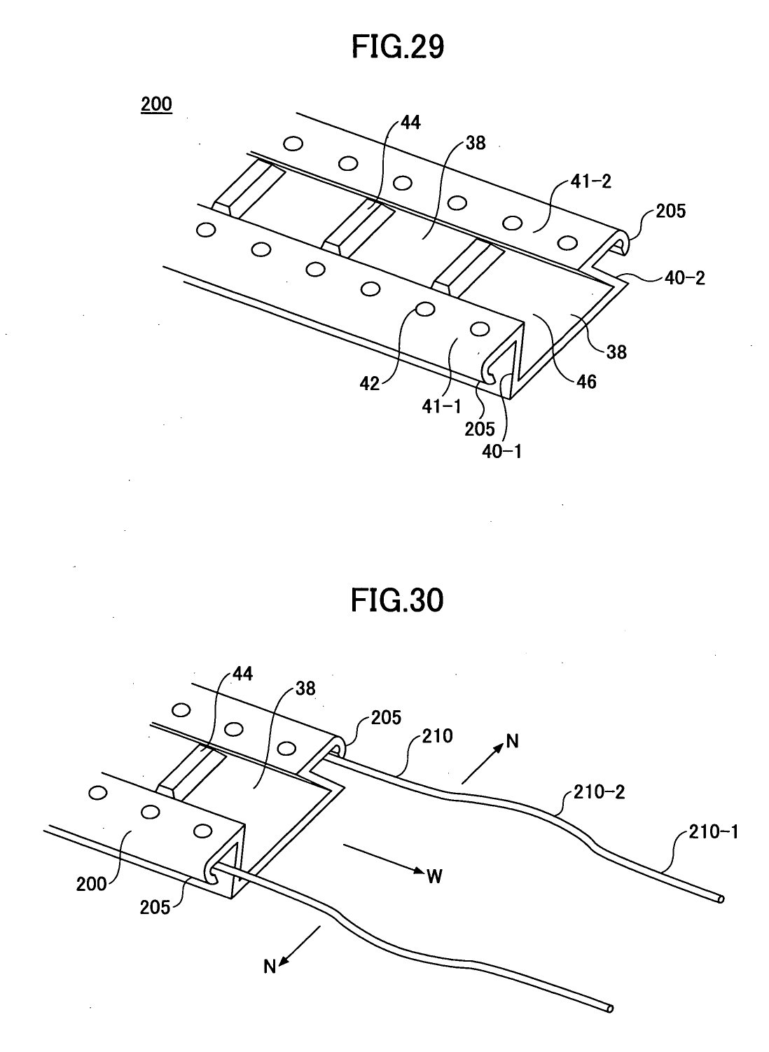

In addition, a structure shown in FIG. 29 or FIG. 30 may be used as the structure whereby the carrier tape is extended.

Here, FIG. 29 is plan view of a carrier tape 200 of a second modification of the carrier tape 11 shown in FIG. 7. FIG. 30 is a perspective view showing a state where the carrier tape 200 shown in FIG. 29 is expanded.

Referring to FIG. 29, edge parts of the top part walls 41-1 and 41-2 of the carrier tape 200 extend and are bent so as to form circular arc shapes toward to the side walls 40-1 and 40-2, and thereby a rail receiving part 205 is formed.

As shown in FIG. 30, two rails 210 made of stick-state metal such as wire are inserted into the rail receiving parts 205 of the carrier tape 200. A straight line part 210-1 and a curved part 210-2 curving to the outside of the running direction of the tape 200 are provided in the rail 210. The rails 210 are provided between the large rollers 12-1 and 12-2 or the first roller couples 14-1 and the second roller couples 14-2 in the semiconductor device receiving apparatus 10. The curved parts 210-2 are positioned substantially below the opening part 17 for loading/unloading.

Under this structure, if the carrier tape 200 runs in the direction shown by an arrow W in FIG. 30, the carrier tape 200 is extended in the directions shown by the arrows N when the carrier tape 200 passes through the curved part 210-2 of the rail 210, so that the semiconductor device can be loaded and unloaded against the element receiving part 38 of the carrier tape 200.

The extended state of the carrier tape 200 is turned off when the extended part of the carrier tape 200 passes through the straight line part 210-1 of the rail 210, so that the side walls 40-1 and 40-2 of the carrier tape 11 are elastically moved back to the original positions.

Thus, in the examples shown in FIG. 19 through FIG. 30, the mechanism configured to easily extend the carrier tape where the semiconductor device can be received and held is provided inside of the semiconductor device receiving apparatus having the sealed structure. Therefore, it is possible to easily load or unload the semiconductor device onto or from the element receiving part of the carrier tape while adhesion of dust or foreign particles to the semiconductor device is avoided.

Next, a receiving method of the semiconductor device in the element receiving part of the carrier tape in the electronic device receiving apparatus is discussed.

In the following explanations, as shown in FIG. 4, an example is discussed where the first reel 13 is used as the supply reel of the carrier tape 11 and the second reel 15 is used as a winding reel of the carrier tape 11 so that the carrier tape 11 runs in the direction shown by the arrow C.

The carrier tape 11 runs inside of the semiconductor device receiving apparatus 10 filled up with gas from the gas inflow opening 24. When a designated element receiving part 38 shown in FIG. 7 of the carrier tape 11 where the semiconductor device 38 should be received and placed is positioned below the opening part 17 for loading/unloading, whether the semiconductor device is received in the carrier tape 11 is detected by the first sensor 20 provided below the carrier tape 11 and/or the second sensor 21 provided in the vicinity of the window 22 of the upper surface of the semiconductor device receiving apparatus 10.

If it is found that the semiconductor device 36 is not received in the element receiving part 38 of the carrier tape 11, the air cylinder 54 is operated so that the first door 52 is slid from the opening part 50 in the direction shown by the arrow G on the same plane surface, and thereby the opening part 17 for loading/unloading is opened shown in FIG. 9. On the other hand, as shown in FIG. 10, the first aperture mechanism body 60 is opened so that the opening part 17 for loading/unloading is opened.

In addition, in the structure shown in FIG. 17, the first door 52 provided at the upper surface of the opening part 77 for loading/unloading is opened and the second door 57 provided at the lower surface of the opening part 77 for loading/unloading is opened so that the opening part 77 for loading/unloading is opened. Furthermore, in the structure shown in FIG. 17, the first aperture mechanism body 60 provided at the upper surface of the opening part 77 for loading/unloading is opened and the second aperture mechanism body 80 provided at the lower surface of the opening part 77 for loading/unloading is opened so that the opening part 77 for loading/unloading is opened. At this time, the carrier tape extending mechanism is operated at the same time.

In the example shown in FIG. 20, the pin 90 projects from the lower part of the carrier tape 11 upward and the jig 95 having the pin 90 is moved in the direction shown by the arrow N by the air cylinder 93. In the example shown in FIG. 21, the electromagnet 94 is operated so that the lower part of the jig 95 having the pin 90 is moved by magnetic force in the direction shown by the arrow Q and the jig 95 is inclined, and thereby the pin 90 is moved in the direction shown by the arrow P, namely to the outside.

In the example shown in FIG. 23, the de-centering causing part 170 is pressed from the outside of the semiconductor device receiving apparatus 150 as shown by the arrow S, so that the sprockets 161 and 162 are inclined (de-centered) and the pin 164 upward projecting from the hole 42 formed in the carrier tape 11 is moved in the direction shown by the arrow R.

In the example shown in FIG. 24, the external force S is applied to the sprockets 161 and 162 and the rotating member 176 is rotated with respect to the shaft part 177 in the direction shown by the arrow T, so that the moving body 175 is moved along an inside taper surfaces of the sprockets 161 and 162 in the direction shown by the arrow U. By such an operation, the upper parts of the sprockets 161 and 162 are tilted outside and the pin 164 upward projecting form the hole 42 formed in the carrier tape 11 is moved in the direction shown by the arrow R.

Furthermore, in the example shown in FIG. 25, the electromagnet 94 is operated so that the lower part of the sprockets 161 and 162 is moved in the direction shown by the arrow Q by a magnetic force and tilted. As a result of this, the pin 164 upward projecting form the hole 42 formed in the carrier tape 11 is moved in the direction shown by the arrow N in FIG. 25.

In the example shown in FIG. 26, the sprockets 161 and 162 having the jigs 164 are moved in the direction shown by the arrow N by the air cylinder 93.

By such an opening process of the carrier tape, the carrier tape 11 is elastically extended in the direction shown by the arrow N (See FIG. 19) so that the semiconductor device 36 can be received in the element receiving part 38 of the carrier tape 11.

In the examples shown in FIG. 27 through FIG. 30, when the designated element receiving part 38 of the carrier tape 110 or 200 where the semiconductor device 38 should be received and placed is positioned below the opening part 17 for loading/unloading, the side wall parts of the carrier tape 110 or 200 are elastically extended in the direction shown by the arrow N, so that the semiconductor device 36 can be inserted in the element receiving part 38 of the carrier tape 110 or 200.

In this state, by the adhesion head or the like, the semiconductor device 36 is inserted from the top part walls 41-1 and 41-2 (See FIG. 7) of the carrier tape 11, so that the semiconductor device 36 is received in the element receiving part 38 of the carrier tape 11.

Then, the side walls 40-1 and 40-2 (See FIG. 7) of the carrier tape 11 are returned to the original position, so that the semiconductor device 36 received in the element receiving part 38 is held by the side walls 40-1 and 40-2.

In the example shown in FIG. 20, moving of the jig 95 in the direction shown by the arrow N by the air cylinder 93 is turned off.

In the example shown in FIG. 21, the operation of the electromagnet 94 is turned off so that the inclination of the jig 95 is turned off and the pin 90 is lowered.

In the example shown in FIG. 23, pushing of the de-centering causing part 170 is stopped so that the inclination of the sprockets 161 and 162 is turned off.

In the example shown in FIG. 24, the moving body 175 is moved in the direction opposite to the direction shown by the arrow U so that the inclination of the sprockets 161 and 162 are turned off.

In the example shown in FIG. 25, the operation of the electromagnet 94 is turned off so that the inclination of the sprockets 161 and 162 are turned off.

In the example shown in FIG. 26, moving of the sprockets 161 and 162 in the direction shown by the arrow N by the air cylinder 93 is turned off.

Next, the opening part 17(77) for loading/unloading of the semiconductor device receiving apparatus 10 is closed.

In the structure shown in FIG. 9, the operation of the air cylinder 54 is turned off and the first door 52 is slid from the opening part 50 in the direction shown by the arrow H, so that the opening part 17 for loading/unloading is closed.

In the structure shown in FIG. 10, the first aperture mechanism body 60 is closed, so that the opening part 17 for loading/unloading is closed.

In the structure shown in FIG. 17, the second door 57 provided at the lower surface of the opening 77 for loading/unloading is closed and then the first door 52 provided at the upper surface of the opening part 77 for loading/unloading is closed.

In the structure shown in FIG. 18, the second aperture mechanism body 80 provided at the lower surface of the opening 77 for loading/unloading is closed and then the first aperture mechanism body 60 provided at the upper surface of the opening part 77 for loading/unloading is closed.

After that, one pitch of the carrier tape 11 is moved in the direction shown by the arrow C in FIG. 4 so that the other semiconductor device can be received in the element receiving part of the carrier tape 11.

Next, a method of loading and unloading the semiconductor device to and from the carrier tape is discussed.

Here, the first reel 13 is used as the supply reel of the carrier tape 11 and the second reel 15 is used as the winding reel of the carrier tape 11.

In other words, in the semiconductor device receiving apparatus 10, the carrier tape 11 wound in advance with respect to the first reel 13 is run in a single direction (in the direction shown by the arrow C in FIG. 4, for example) so that the semiconductor device 36 is inserted and received in the element receiving part 38 of the carrier tape 11 and the carrier tape 11 is wound with respect to the second reel 15.

In addition, the carrier tape 11 wound with respect to the second reel 15 is run in a direction opposite to the single direction (in the direction opposite to the direction shown by the arrow C in FIG. 4, for example) so that the semiconductor device 36 is taken out from the element receiving part 38 of the carrier tape 11 and the empty carrier tape 11 is wound with respect to the first reel 13.

The empty carrier tape 11 is run in the single direction again so that the semiconductor device 36 is inserted and received in the element receiving part 38 of the carrier tape 11. Thus, according to such a method, it is possible to reuse the carrier tape 11.

The carrier tape 11 runs in the direction opposite to the direction shown by the arrow C, in the semiconductor device receiving apparatus 10 where gas is filled up from the gas inflow opening 24. When the semiconductor device 36 which should be taken out is positioned below the opening part 17 for loading/unloading, whether the semiconductor device is received in the element receiving part of the carrier tape 11 is detected by the first sensor 20 provided below the carrier tape 11 and/or the second sensor 21 provided in the vicinity of the window 22 of the upper surface of the semiconductor device receiving apparatus 10.

If it is found that the semiconductor device 36 is received in the element receiving part 38 of the carrier tape 11, the opening part 17 for loading/unloading is opened.

At the same time, the carrier tape extending mechanism 19 is operated, so that the semiconductor device 36 placed in the element receiving part 38 of the carrier tape 11 is taken out from the opening part 46 formed by the top part walls 41-1 and 41-2 of the carrier tape 11 by the adhesion jig. See FIG. 7.

Then, the side walls 40-1 and 40-2 (See FIG. 7) are elastically returned to the original position,

Next, the opening part 17(77) for loading/unloading of the semiconductor device receiving apparatus 10 is closed.

In the structure shown in FIG. 9 or FIG. 10, the opening part 17 for loading/unloading is closed by the-same way as the way in the case where the semiconductor device 36 is inserted in the element receiving part 38 of the carrier tape 11.

In the structure shown in FIG. 17 or FIG. 18, after the semiconductor device 36 is pick up from the carrier tape 11 by the adhesion jig, the second door 57 or the second aperture mechanism body 80 provided at the lower surface of the opening 77 for loading/unloading is closed.

And then, after the jig further goes up so that the semiconductor device 36 is taken out from the semiconductor device receiving apparatus 10 by the adhesion jig, the first door 52 or the first aperture mechanism body 60 provided at the upper surface of the opening part 77 for loading/unloading is closed.

In this case, as compared with a case where first door 52 or the first aperture mechanism body 60 is provided at the only upper surface of the opening 77 for loading/unloading, it is possible to secure the sealability of the inside of the semiconductor device receiving apparatus 10 and the reduction of the pressure of the inside of the semiconductor device receiving apparatus 10 at the time when the opening part 77 for loading/unloading is opened or closed can be prevented. Therefore, the amount of gas consumed from the gas inflow part 24 in the semiconductor device receiving apparatus 100 is reduced.

After that, the carrier tape 11 is moved one pitch in the direction shown by the arrow C in FIG. 4 so that another semiconductor device can be inserted in the element receiving part of the carrier tape 11.

Thus, since the inside of the semiconductor device receiving apparatus of this embodiment has the sealed structure, the semiconductor device can be protected against dust or foreign particles.

In addition, in the semiconductor device receiving apparatus, a carrier tape capable of holding the semiconductor device is easily and elastically extended and the opening part for loading/unloading is opened, so that it is possible to easily and efficiently load and unload the semiconductor device against the carrier tape.

In addition, the semiconductor device can be carried in a state where the semiconductor device is received in the semiconductor device receiving apparatus. Therefore, good carry-ability is obtained. Hence, increase of the carrying cost can be prevented. Furthermore, the carrier tape can be reused.

In addition, the semiconductor device receiving apparatus has heat-resistant abilities. Therefore, in a case where heating process such as baking is applied to the semiconductor device, re-stuffing the semiconductor device into another receiving apparatus or the like is not required. The heating process of the semiconductor device can be implemented where the semiconductor device is received in the semiconductor device receiving apparatus.

The present invention is not limited to these embodiments, but variations and modifications may be made without departing from the scope of the present invention.

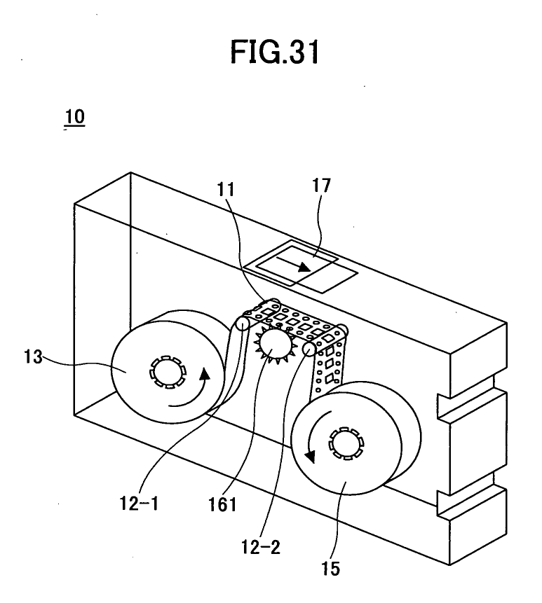

For example, the way of winding the carrier tape 11 in the semiconductor device receiving apparatus 10 is not limited to the way shown in FIG. 4. As shown in FIG. 31, which is a perspective view showing an internal structure of a semiconductor device receiving apparatus wherein the way of winding the carrier tape is different from the way of winding the carrier tape in the semiconductor device receiving apparatus shown in FIG. 4, the second reel 15 may be rotated in a direction opposite to a rotational direction of the first reel 13, so that the surface where the semiconductor device 36 is placed on the carrier tape 11 may face the inside of the first reel 13 or the second reel 15.

This patent application is based on Japanese Priority Patent Application No. 2005-375681 filed on Dec. 27, 2005, the entire contents of which are hereby incorporated by reference.

What is claimed is:

1. An electronic device receiving apparatus having a sealed structure, comprising:
a tape whereby an electronic device is received in the electronic device receiving apparatus;
wherein the tape elastically holds the electronic device and runs inside of the electronic device receiving apparatus;
an opening part for loading/unloading and a tape extending mechanism are provided inside of the electronic device receiving apparatus;
the opening part for loading/unloading is provided above the tape so that the electronic device is loaded onto and unloaded from the tape;
the opening part for loading/unloading has an opening part configured to open the electronic device receiving apparatus; and
the tape extending part extends the tape in a direction substantially perpendicular to a running direction of the tape.

2. The electronic device receiving apparatus as claimed in claim 1,
wherein the opening part for loading/unloading includes a door; and
the opening part of the opening part for loading/unloading is opened and closed by sliding the door in a horizontal direction.

3. The electronic device receiving apparatus as claimed in claim 1,
wherein the opening part for loading/unloading includes an aperture mechanism part; and
the opening part of the opening part for loading/unloading is opened and closed by rotating aperture wings of the aperture mechanism part in a same plane surface.

4. The electronic device receiving apparatus as claimed in claim 1,
wherein the opening part for loading/unloading includes a first door and a second door;
the first door is provided at the opening part positioned in an upper surface of the opening part for loading/unloading;
the second door is provided in a lower surface of the opening part for loading/unloading; and
the opening part of the opening part for loading/unloading is opened and closed by sliding the first door and the second door in a horizontal direction.

5. The electronic device receiving apparatus as claimed in claim 1,
wherein the opening part for loading/unloading includes a first aperture mechanism body and a second aperture mechanism body;
the first aperture mechanism body is provided at the opening part positioned in an upper surface of the opening part for loading/unloading;
the second aperture mechanism body is provided in a lower surface of the opening part for loading/unloading; and
the opening part of the opening part for loading/unloading is opened and closed by rotating aperture wings of the first aperture mechanism body and the second aperture mechanism body in a same plane surface.

6. The electronic device receiving apparatus as claimed in claim 1,
wherein a hole is formed in a side edge part of the tape; and
the tape extending mechanism includes a jig having a pin inserted into the hole of the tape and a jig moving member moving the jig in the direction substantially perpendicular to the running direction of the tape.

7. The electronic device receiving apparatus as claimed in claim 6,
wherein the jig moving member is an air cylinder.

8. The electronic device receiving apparatus as claimed in claim 6,
wherein the jig moving member is an electromagnet.

9. The electronic device receiving apparatus as claimed in claim 1,
wherein a hole is formed in a side edge part of the tape; and
the tape extending mechanism includes a sprocket having a pin inserted into the hole of the tape and a sprocket inclination member inclining the sprocket so that the pin is moved in the direction substantially perpendicular to the running direction of the tape.

10. The electronic device receiving apparatus as claimed in claim 9,
wherein the sprocket inclination member is a de-centering causing part provided at a side surface of the electronic device receiving apparatus; and
the sprocket is inclined by pushing the de-centering causing part so that a pushing force is transferred to the sprocket.

11. The electronic device receiving apparatus as claimed in claim 9,
wherein the sprocket inclination member is a moving body having a taper part of a designated angle and coming in contact with the sprocket; and
the sprocket is inclined by moving the moving body upward or downward.

12. The electronic device receiving apparatus as claimed in claim 9,
wherein the sprocket inclination member is an air cylinder.

13. The electronic device receiving apparatus as claimed in claim 9,
wherein the sprocket inclination member is an electromagnet.

14. The electronic device receiving apparatus as claimed in claim 1,
wherein a plurality of holes are formed in a side edge part of the tape; and
one of the holes, the one hole being formed in a part of the tape next to a part where the electronic device is held, is positioned more to an inside than other of the holes.

15. The electronic device receiving apparatus as claimed in claim 1,
wherein a rail along which the tape runs is provided inside of the electronic device receiving apparatus;
the rail has a straight part extending in the running direction of the tape and a curved part curving to an outside of the running direction of the tape; and
a side edge part of the tape is bent so as to form a circular arc-shaped rail receiving part for receiving the rail.

16. The electronic device receiving apparatus as claimed in claim 1, further comprising:
a detection part detecting whether the electronic device is placed at a part positioned below the opening part for loading/unloading.

17. A method of loading/unloading an electronic device at an electronic device receiving apparatus, the electronic device receiving apparatus having a sealed structure in which the electronic device is received by using a tape, the tape being capable of elastically holding the electronic device and running inside of the electronic device receiving apparatus, the method comprising the steps of:
opening an opening part for loading/unloading of the electronic device receiving apparatus when a designated part of the tape is positioned below the opening part for loading/unloading; and
extending the tape inside of the electronic device receiving apparatus in a direction substantially perpendicular to a running direction of the tape, so that the electronic device is loaded to and unloaded from against the tape.

18. The method of loading/unloading the electronic device at the electronic device receiving apparatus as claimed in claim 17, further comprising a step of:
closing the opening part for loading/unloading;
wherein a lower surface of the opening part for loading/unloading is closed after the electronic device is taken out from the tape, the electronic device is picked up from the electronic device receiving apparatus, and then an upper surface of the opening part for loading/unloading is closed, in the step of closing the opening part for loading/unloading.

19. The method of loading/unloading the electronic device at the electronic device receiving apparatus as claimed in claim 17,
wherein the step of opening an opening part for loading/unloading is implemented based on detection of the electronic device at a designated part of the tape, the designated part being positioned below the opening part for loading/unloading.

20. The method of loading/unloading the electronic device at the electronic device receiving apparatus as claimed in claim 17,
wherein the electronic device is loaded onto the tape while the tape runs in a first direction and is wound; and
the electronic device is unloaded from the tape while the tape runs in a second direction opposite to the first direction.
